(19) United States
(12) Patent Application Publication
(10) Pub. No.: US 2019/0002633 A1
(43) Pub. Date: Jan. 3, 2019

(54) FUNCTIONALIZED (POLY)ALKOXYLATED (PER)FLUOROPOLYETHER POLYMERS

(71) Applicant: SOLVAY SPECIALTY POLYMERS ITALY S.P.A., Bollate (IT)

(72) Inventors: Giovanni SIMEONE, Solaro, MI (US); Pier Antonio GUARDA, Arese (IT); Silvia Rita PETRICCI, Bresso (IT)

(21) Appl. No.: 16/065,668

(22) PCT Filed: Dec. 20, 2016
(86) PCT No.: PCT/EP2016/082018

§ 371 Date: Jun. 22, 2018

(30) Foreign Application Priority Data
Dec. 22, 2015 (EP) 15201931.1

(51) Int. Cl. C08G 65/00; C08G 65/332; C08G 65/333; C09D 133/14; C09D 7/65; C09D 5/00

(52) U.S. Cl. CPC C08G 65/007; C08G 65/3322; C08G 65/33355; C08G 2150/00; C09D 7/65; C09D 5/00; C09D 133/14

(57) ABSTRACT

The present invention relates to novel derivatives of (poly)alkoxylated (per)fluoropolyethers, also referred to as PFPE-PAGs, comprising unsaturated end groups bearing acrylate, allylic or vinylic moieties.

### CROSS-REFERENCE TO RELATED APPLICATION

This application claims priority to European application No. 15201931.1, filed on 22 Dec. 2015, the whole content of which is incorporated herein by reference for all purposes.

### TECHNICAL FIELD

The present invention relates to novel derivatives of (poly)alkoxylated (per)fluoropolyethers, also referred to as PFPE-PAGs, comprising unsaturated end groups.

### BACKGROUND ART

(Per)fluoropolyethers (PFPE) polymers comprising functional groups at their chain ends are potentially interesting materials from the industrial perspective, and hence in the last years they have been the subject of several patent and patent applications.

For example, polyfunctional poly(perfluoro alkylene oxides) and their preparation have been disclosed for example in U.S. Pat. No. 3,810,874 (MINNESOTA MINING AND MANUFACTURING COMPANY) 14 May 1974, which discloses compounds having the following formula:

A-[CF₂—O—(CF₂CF₂O)ₘ—(CF₂O)ₙ—CF₂]-A′

wherein A and A′ are the reactive radicals of formula

—X_{a′}YZ_{b′} or —X′_{a′}Y′Z′_{b′} wherein

X and X′ are each a polyvalent, preferably a divalent, linking organic radical

a and a′ the same or different are 0 or 1

b and b′ the same or different are integers of 1-3

Y and Y′ are polyvalent linking organic radicals free of olefinic insaturation

Z and Z′ are polymerizable functional groups.

However, this patent document does not disclose functionalized (per)fluoropolyethers derivatives comprising (poly)alkoxylated groups.

More in particular, (per)fluoropolyether polymers comprising (meth)acrylic end groups have been disclosed in the art, for example in US 2011293943 (E.I. DU PONT DE NEMOURS AND COMPANY), which discloses fluoropolymer comprising—among the others—repeating units of formulae:

[R_{f}—X—Y—C(O)—CZ—CH₂]ₐ—(I)

[R_{f}—X—Y—C(O)—CH—CH₂]_{b}—(II)

wherein

R_{f} is a straight or branched perfluoroalkyl group having 2-6 carbon atoms;

X is an organic divalent linking group having from about 1 to about 20 carbon atoms, optionally containing a triazole, oxygen, nitrogen, or sulphur or any combination thereof;

Y is O, S or N(R) where R is H or C₁ to C₂₀ alkyl.

Fluorinated (meth)acrylate monomers suitable to provide unit (I) have the general formula R_{f}—X—Y—C(O)—C(Z)═CH₂, and fluorinated (meth)acrylate monomers suitable to provide unit (II) have the general formula R_{f}—X—Y—C(O)—CH═CH₂, wherein R_{f}, X, Y and Z are as defined above.

EP 0394927 B (AUSIMONT S.P.A.) discloses a process to obtain methacrylates of fluorinated alcohols by direct esterification of said alcohols with methacrylic acid.

U.S. Pat. No. 6,391,459 (DSM N.V.) discloses a radiation-curable composition comprising a fluorinated oligomer in an amount of from 30 to 90% by weight based on the total weight of the composition. Fluorinated oligomers are obtained starting from Fomblin® Z-Dol TX, which were endcapped with ethylene oxide. However, in the 90s, only grades comprising one or two ethylene oxide units were available on the market.

WO 2010/094661 A (SOLVAY SOLEXIS S.P.A.) discloses a method for replicating a pattern, which comprises the use of a curable perfluoropolyether composition comprising a PFPE polymer comprising at least two unsaturated moieties.

None of the abovementioned patent application discloses functionalized (per)fluoropolyethers derivatives, comprising (poly)alkoxylated groups.

WO 2009/076389 (3M INNOVATIVE PROPERTIES COMPANY) discloses articles, such as optical displays and protective films, comprising substrate having a surface layer comprising the reaction product of a mixture comprising a non-fluorinated binder precursor and at least one polymerizable perfluoropolyether polymer. This patent application discloses polymers comprising a HFPO moiety, i.e. a moiety having the following structure: F(CF(CF₃)CF₂O)ₐCF(CF₃)—. The final polymers comprise a hydrogenated backbone and are obtained via reaction of at least copolymerizable monomers, each bearing one unsaturated moiety, such as for example —OC(═O)CH═CH₂ or —OC(═O)C(CH₃)═CH₂.

WO 03/072625 A (LUVANTIX CO., LTD) discloses a photocurable resin composition useful for preparing an optical waveguide, which comprises a fluorinated photocurable urethane oligomer of formula (I), a reactive monomer and a photocurable initiator.

EP 0165059 A (MINNESOTA MINING AND MANUFACTURING COMPANY) relates to a low surface energy material that is a hydrosilation reaction product of a compound containing fluorine and aliphatic unsaturation with a compound containing silicon-bonded hydrogen. This patent application generally disclose the reaction between methylol-terminated perfluoropolyether (e.g. HOCH₂(CₐF₂ₐO)_{f}(CₐF₂ₐ)CH₂ OH) with ethylenically-unsaturated halides. However, this patent application does not disclose (per)fluoropolyethers derivatives comprising (poly)alkoxylated groups.

US 20130084458 (TDK CORPORATION) discloses a hard coat composition comprising a urethane acrylate, a fluorine-containing polyether compound having an active energy ray reactive group via a urethane bond at each of both ends of a molecular chain containing a perfluoropolyether group; a second fluorine-containing polyether compound having an active energy ray reactive group via a urethane bond at one end of a molecular chain containing a perfluoropolyether group and not having an energy ray reactive group at the other end; a curable compound having two or more reactive energy ray polymerizing groups. However, this patent application does not disclose (per)fluoropolyethers derivatives comprising a specific number of (poly)alkoxylated groups.

EP 0622353 B (AUSIMONT S.P.A.) discloses perfluoropolyethers containing (meth)acrylic groups obtainable by co-polymerization of:

a) 1-50% by weight of a monomer having general formula:

Y—CF₂OR_{f}CFXCH₂(OCH₂CH₂)ₚOCOCR═CH₂ (I)

wherein Y is F, Cl, CF₃, C₂F₅, C₃F₇, C₄F₉;

X is F, CF₃;

p is an integer from 1 to 5;

Rf represents a radical having perfluoropolyetheral structure of average molecular weight of from 400 to 3000, formed by sequence of oxyfluoroalkylenic units, which preferably always comprises a branched unit of formula —[CF₂CF(CF₃)O]—; and

R is H, CH₃;

b) 40-90% by weight of one or more monomer(s) of formula

CH₂═CR₁—COOA (IV)

wherein R₁ is H, CH₃, Cl, F;

A is an alkyl radical having from 1 to 12 carbon atoms or a fluoroalkyl radical having from 1 to 10 carbon atoms or an aliphatic or aromatic cyclic group having from 6 to 8 carbon atoms;

c) 2-30% by weight of one or more monomer(s) of formula:

CH₂═CR₁—CO—W—B (V)

wherein R₁ has the same meanings defined above;

W is O, NH;

B is H, (CH₂)ₛB₁ with s=1 to 5, B₁=—COOH, —OH, —CH═CH₂, —NCO, —CO—CH₂CO—CH₃, —Si(OR₂)₃ with alkylic R₂ groups having from 1 to 5 carbon atoms.

Thus, this document only discloses monofunctional perfluoropolyether polymers of formula (I), which comprise from 1 to 5 alkoxylated units of formula —(OCH₂CH₂)— and are used as intermediate products.

In addition, the only polymer used to provide a composition in the examples has the following formula: CF₃O(C₃F₆O)ₘ(CF₂O)ₙCF₂CH₂OCH 2CH₂O—C(O)C(CH₃)═CH₂

wherein p is 1; and this polymer is used in the compositions provided in Table 1 in an amount of from about 43 to about 62 wt. % based on the total weight of the compositions.

In addition, it is known that polymers having low molecular weight, such as the intermediate compounds of formula (I) disclosed in this patent application, have potential toxicological problems that made them little acceptable to environmental and public health perspective.

### SUMMARY OF INVENTION

Now, the Applicant surprisingly found novel (per)fluoropolyether polymers comprising (poly)oxyalkylene chains, which are accessible through effective synthetic pathways suitable for industrial implementation and have a more favourable toxicological profile.

In addition, the Applicant also found that these novel (per)fluoropolyether polymers can be advantageously used as additives in coating compositions in order to provide outstanding water- and oil-repellency, easy to clean and stain removal properties, as well as anti-fingerprint performances to the substrate to which the composition is applied.

Even more, the Applicant surprisingly found that certain di-functional (per)fluoropolyether polymers comprising a specific number of (poly)oxyalkylene units can be used as additives in clear coating compositions in order to provide transparent coatings while maintaining outstanding water- and oil-repellency, easy to clean and stain removal properties, as well as anti-fingerprint performances.

Thus, in a first aspect, the present invention relates to a (per)fluoropolyether polymer [polymer P] comprising:
at least one (per)fluoropolyoxyalkylene chain [chain (R_{pf})];
at least one (poly)oxyalkylene chain [chain (Rₐ)] comprising more than 2 fluorine-free oxyalkylene units, said units being the same or different each other and being selected from —CH₂CH(J)O—, wherein J is independently selected from hydrogen atom, straight or branched alkyl or aryl, preferably hydrogen atom, methyl, ethyl or phenyl; and
at least one unsaturated moiety [moiety U];

wherein said at least one moiety U is bonded to said at least one chain (R_{pf}) via said at least one chain (Rₐ);

provided that said polymer (P) is different from a polymer of formula

Y—CF₂OR_{f}CFXCH₂(OCH₂CH₂)ₚOCOCR═CH₂

wherein

Y is F, Cl, a perfluoroalkyl group having from 1 to 4 carbon atoms;

X is F, CF₃;

p is an integer from 1 to 5;

R_{f} represents a radical having perfluoropolyetheral structure; and

R is H, CH₃.

Advantageously, the Applicant also noted that the novel polymers according to the present invention comprise both a hydrophobic segment, i.e. chain (R_{pf}), and a hydrophilic hydrogenated spacer, i.e. chain (Rₐ), the latter improving the compatibility of the polymers with hydrophobic reactants, such that novel polymers (P) as defined above can be used as intermediates in the synthesis of further polymers.

### DESCRIPTION OF EMBODIMENTS

For the purpose of the present description and of the following claims:
the use of parentheses around symbols or numbers identifying the formulae, for example in expressions like “polymer (P)”, etc., has the mere purpose of better distinguishing the symbol or number from the rest of the text and, hence, said parenthesis can also be omitted;
the acronym “PFPE” stands for “(per)fluoropolyether” and, when used as substantive, is intended to mean either the singular or the plural from, depending on the context;
the term “(per)fluoropolyether” is intended to indicate fully or partially fluorinated polyether.

Preferably, said chain (R_{pf}) is a chain of formula —O-D-(CFX^{#})_{z1}—O(R_{f}) (CFX*)_{z2}-D*—O—

wherein

z1 and z2, equal or different from each other, are equal to or higher than 1;

X^{#} and X*, equal or different from each other, are —F or —CF₃,

provided that when z1 and/or z2 are higher than 1, X^{#} and X* are —F;

D and D*, equal or different from each other, are an alkylene chain comprising from 1 to 6 and even more preferably from 1 to 3 carbon atoms, said alkyl chain being optionally substituted with at least one perfluoroalkyl group comprising from 1 to 3 carbon atoms;

(R_{f}) comprises, preferably consists of, repeating units R^{o}, said repeating units being independently selected from the group consisting of:

(i) —CFXO—, wherein X is F or CF₃;

(ii) —CFXCFXO—, wherein X, equal or different at each occurrence, is F or CF₃, with the proviso that at least one of X is —F;

(iii) —CF₂CF₂CW₂O—, wherein each of W, equal or different from each other, are F, Cl, H;

(iv) —CF₂CF₂CF₂CF₂O—;

(v) —(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being chosen among the following: —CFXO—, —CF₂CFXO—, —CF₂CF₂CF₂O—, —CF₂CF₂CF₂CF₂O—, with each of each of X being independently F or CF₃ and T being a C₁-C₃ perfluoroalkyl group.

Preferably, z1 and z2, equal or different from each other, are from 1 to 10, more preferably from 1 to 6 and even more preferably from 1 to 3.

Preferably, D and D*, equal or different from each other, are a chain of formula —CH₂—, —CH₂CH₂- or —CH(CF₃)—.

Preferably, chain (R_{f}) complies with the following formula:

—[(CFX¹O)_{g1}(CFX²CFX³O)_{g2}(CF₂CF₂CF₂O)_{g3}(CF₂CF₂CF₂CF₂O)_{g4}]— (R_{f}-I)

wherein
X¹ is independently selected from —F and —CF₃,
X², X³, equal or different from each other and at each occurrence, are independently —F, —CF₃, with the proviso that at least one of X is —F;
g1, g2, g3, and g4, equal or different from each other, are independently integers ≥0, such that g1+g2+g3+g4 is in the range from 2 to 300, preferably from 2 to 100; should at least two of g1, g2, g3 and g4 be different from zero, the different recurring units are generally statistically distributed along the chain.

More preferably, chain (R_{f}) is selected from chains of formula:

—[(CF₂CF₂O)ₐ(CF₂O)ₐ₂]— (R_{f}—IIA)

wherein:
a1 and a2 are independently integers ≥0 such that the number average molecular weight is between 400 and 10,000, preferably between 400 and 5,000; both a1 and a2 are preferably different from zero, with the ratio a1/a2 being preferably comprised between 0.1 and 10;

—[(CF₂CF₂O)_{b1}(CF₂O)_{b2}(CF(CF₃)O)_{b3}(CF₂CF(CF₃)O)_{b4}]— (R_{f}-IIB)

wherein:

b1, b2, b3, b4, are independently integers ≥0 such that the number average molecular weight is between 400 and 10,000, preferably between 400 and 5,000; preferably b1 is 0, b2, b3, b4 are >0, with the ratio b4/(b2+b3) being 1;

—[(CF₂CF₂O)_{c1}(CF₂O)_{c2}(CF₂(CF₂)_{cw}CF₂O)_{c3}]— (R_{f}—IIC)

wherein:

cw=1 or 2;

c1, c2, and c3 are independently integers 0 chosen so that the number average molecular weight is between 400 and 10,000, preferably between 400 and 5,000; preferably c1, c2 and c3 are all >0, with the ratio c3/(c1+c2) being generally lower than 0.2;

—[(CF₂CF(CF₃)O)_{d}]— (R_{f}—IID)

wherein:

d is an integer >0 such that the number average molecular weight is between 400 and 10,000, preferably between 400 and 5,000;

—[(CF₂CF₂C(Hal*)₂O)ₑ₁—(CF₂CF₂CH₂O)ₑ₂—(CF₂CF₂CH(Hal*)O)ₑ₃]— (R_{f}-IIE)

wherein:
Hal*, equal or different at each occurrence, is a halogen selected from fluorine and chlorine atoms, preferably a fluorine atom;
e1, e2, and e3, equal to or different from each other, are independently integers ≥0 such that the (e1+e2+e3) sum is comprised between 2 and 300.

Still more preferably, chain (R_{f}) complies with formula (R_{f}—III) here below:

—[(CF₂CF₂O)ₐ₁(CF₂O)ₐ₂]— (R_{f}-III)

wherein:
a1, and a2 are integers >0 such that the number average molecular weight is between 400 and 10,000, preferably between 400 and 5,000, with the ratio a1/a2 being generally comprised between 0.1 and 10, more preferably between 0.2 and 5.

Preferably, chain (Rₐ) comprises from 3 to 40, more preferably from 4 to 15 and even more preferably from 4 to 10 fluorine-free oxyalkylene units as defined above.

More preferably, said chain (Rₐ) is selected from:

—(CH₂CH₂O)ⱼ₁— (Ra-I)

—[CH₂CH(CH₃)O]ⱼ₂— (Ra-II)

—[(CH₂CH₂O)ⱼ₃—(CH₂CH(CH₃)O)ⱼ₄]ⱼ₍ₓ₎— (Ra-III)

wherein

j1 and j2, each independently, are an integer from 3 to 50, more preferably from 4 to 40, even more preferably from 4 to 15, and still more preferably from 4 to 10;

j3, j4 and j(x) are integers higher than 1, such that the sum of j3 and j4 is from 3 to 50, more preferably from 4 to 40, even more preferably from 4 to 15, and still more preferably from 4 to 10.

When present, the recurring units having j*1 and j*2 as indexes can be either randomly distributed or they can be arranged to form blocks.

Said moiety U is preferably selected in the group consisting of:

—C(═O)—CR_{H}═CH₂ (U-I)

—C(═O)—NH—CO—CR_{H}═CH₂ (U-II)

—C(═O)—R^{A}—CR_{H}═CH₂ (U-III)

—R_{H1}—CH═CH₂ (U-IV)

wherein

R_{H} is H or a C₁-C₆ alkyl group;

R_{H1} is a sigma bond, an oxygen atom or an alkyl chain having from 1 to 10, preferably from 1 to 6, more preferably from 1 to 3 carbon atoms;

R^{A} is selected from the group consisting of (R^{A}-I) and (R^{A}-II):

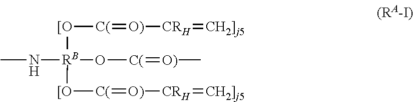

wherein

each of j5 is independently 0 or 1; and

R^{B} is a divalent, trivalent or tetravalent group selected from the group consisting of C₁-C₁₀ aliphatic group; C₃-C₁₂ cycloaliphatic group; C₅-C₁₄ aromatic or alkylaromatic group, optionally comprising at least one heteroatom selected from N, O and S;

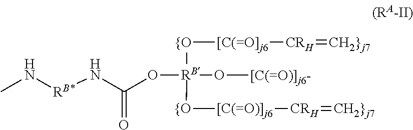

wherein

j6 is 0 or 1;

each j7 is independently 0 or 1;

R^{B′} is a divalent, trivalent or tetravalent group selected from the group consisting of C₁-C₁₀ aliphatic group; C₃-C₁₂ cycloaliphatic group; C₅-C₁₄ aromatic or alkylaromatic group, optionally comprising at least one heteroatom selected from N, O and S;

R^{B*} has the same meanings defined above for R^{B′} or it is a group of formula (R^{B}-I):

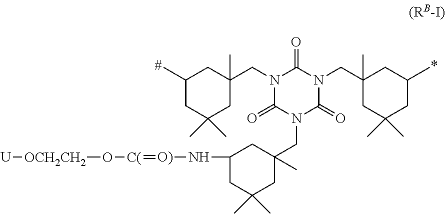

wherein

U is selected from the groups (U-I) to (U-IV) as defined above and

and # indicate the bonding site to the nitrogen atoms in formula (RA-II) above.

More preferably, R_{H1} is selected from a sigma bond, an oxygen atom and an alkyl chain having from 1 to 3 carbon atoms.

More preferably, in formula (R^{A}-I) above, each of j5 is 0 and R^{B} is a divalent group selected from C₁-C₁₀ aliphatic group; C₃-C₁₂ cycloaliphatic group; C₅-C₁₄ aromatic or alkylaromatic group, optionally comprising at least one heteroatom selected from N, O and S.

More preferably, in formula (R^{A}-II) above, each of j7 is 0 and R^{B′} is a divalent group selected from C₁-C₁₀ aliphatic group; C₃-C₁₂ cycloaliphatic group; C₅-C₁₄ aromatic or alkylaromatic group, optionally comprising at least one heteroatom selected from N, O and S.

More preferably, in formula (R^{A}-II) above, R^{B*} is a divalent group selected from C₁-C₁₀ aliphatic group; C₃-C₁₂ cycloaliphatic group; C₅-C₁₄ aromatic or alkylaromatic group, optionally comprising at least one heteroatom selected from N, O and S or it is a group of formula (RB-I) wherein U complies with formula (U-I) or (U-IV) as defined above.

Preferred polymers (P) according to the present invention comprise:
one chain (R_{pf}),
two chains (Rₐ) bonded to opposite sides of said chain (R_{pf}), wherein each chain (Rₐ) bears more than 2, preferably from 3 to 50, more preferably from 4 to 40, even more preferably from 4 to 15 and still more preferably from 4 to 10 fluorine-free oxyalkylene units as defined above and
at least two moieties U as defined above, more preferably from 2 to 6 moieties U as defined above, even more preferably from 2 to 4 moieties U as defined above.

Said chain (Rₐ) and said at least one moiety U are preferably linked via a sigma bond or via a divalent, trivalent or tetravalent linear or branched alkyl chain comprising from 1 to 6 carbon atoms. More preferably, said chain (Rₐ) and said at least one moiety U are linked via a sigma bond or via a divalent or trivalent linear or branched alkyl chain comprising from 1 to 6 carbon atoms.

Polymers P according to the present invention can be represented for example as follows:

T-(R_{pf})—(Rₐ)—(C*)[—U]_{z(x)}

wherein

(R_{pf}), (Rₐ) and U are as defined above

z(x) is an integer from 1 to 3

(C*) is a sigma bond or a divalent, trivalent or tetravalent linear or branched alkyl chain comprising from 1 to 6 carbon atoms, more preferably from 1 to 5 carbon atoms and

T is a group of formula —(Rₐ)—(C*)[—U]_{z(x)} as defined above or a neutral group selected from neutral group selected from —CF₃, —C₂F₅, —C₃F₇, —CF₂Cl, —CF₂CF₂Cl and —C₃F₆Cl.

When T is a neutral group as defined above, polymer P is also referred to as “monofunctional polymer P”. When T is a groups of formula —(Rₐ) —(C*)[—U]_{z(x)} as defined above, polymer P is also referred to as “bifunctional polymer P”.

Preferably, the functionality (F) of polymer P, i.e. the average number of functional groups per molecule of polymer, is from 1 to 2. Bifunctional polymers P typically have a functionality (F) from 1.5 to 1.95, more preferably from 1.7 to 1.9. The functionality (F) can be calculated for example as disclosed in EP 1810987 A (SOLVAY SOLEXIS S.P.A.). Within the present invention, bifunctional polymers P are more preferred.

Preferred polymers (P) according to the present invention comply with the following formulae (P-I) to (P-IV):

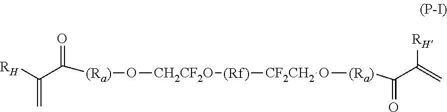

wherein

(R_{f}) is as defined above;

each (Rₐ) is as defined above, more preferably each (Rₐ) complies with formulae (Rₐ-I) and (Rₐ-II) as defined above, and even more preferably with formula (Rₐ-I) as defined above;

R_{H} and R_{H′}, equal or different from each other, are independently H or a C₁-C₆ alkyl group;

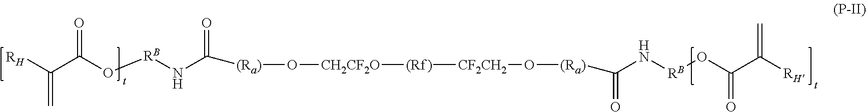

wherein

(R_{f}), (Rₐ), R_{H} and R_{H′} have the same meaning as defined above;

t is 1 or 2; and

each R^{B}, equal to or different from each other, is a divalent group selected from the group consisting of C₁-C₁₀ aliphatic group, C₃-C₁₂ cycloaliphatic group, C₅-C₁₄ aromatic or alkylaromatic group, optionally comprising one or more heteroatoms selected from N, O and S.

More preferably, t is 1, R^{B} is a divalent group selected from C₁-C₆ aliphatic group, and each (Rₐ) complies with formulae (Rₐ-I) and (Rₐ-II) as defined above, and even more preferably with formula (Rₐ-I) as defined above;

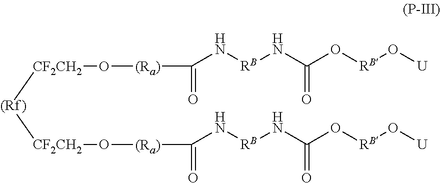

wherein

(R_{f}), (Rₐ) and RB have the same meaning as above detailed;

each of R^{B′}, equal to or different from each other, is a divalent group selected from the group consisting of C₁-C₁₀ aliphatic group, C₃-C₁₂ cycloaliphatic group, C₆-C₁₄ aromatic or alkylaromatic group, optionally comprising one or more heteroatoms selected from N, O and S.

More preferably, each (Rₐ) complies with formulae (Rₐ-I) and (Rₐ-II) as defined above, and even more preferably with formula (Rₐ-I) as defined above;

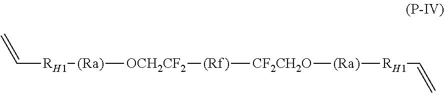

wherein

(R_{f}), (Rₐ) and R_{H1} have the same meaning as above detailed; more preferably each (Rₐ) complies with formulae (Rₐ-I) and (Rₐ-II) as defined above, and even more preferably with formula (Rₐ-I) as defined above.

More preferred polymers (P) are selected from the group consisting of:

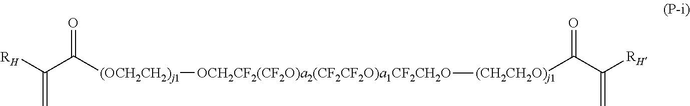

wherein

R_{H} and R_{H′} each independently are selected from hydrogen and methyl;

a1 and a2 are as defined above; and

each of j1 is an integer from 4 to 10;

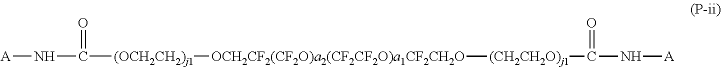

wherein

a1 and a2 are as defined above;

each of j1 is an integer from 4 to 10; and

each A is a group of formula

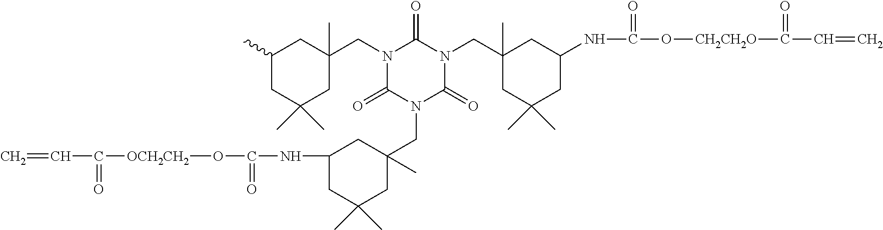

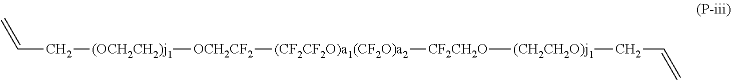

wherein

a1 and a2 are as defined above and

each of j1 is an integer from 4 to 10;

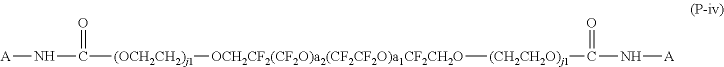

wherein

a1 and a2 are as defined above;

each of j1 is an integer from 4 to 10; and

each A is a group of formula

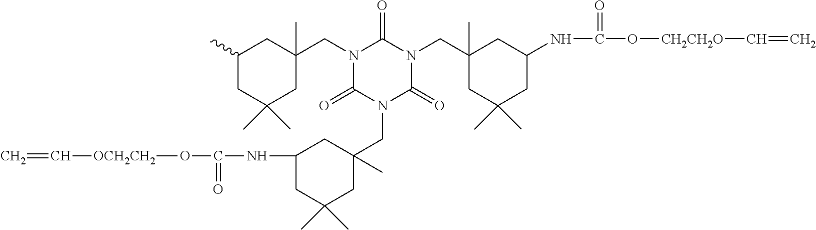

Advantageously, the method for preparing polymers (P) according to the present invention is easy to perform and convenient on industrial scale.

Polymers (P) according to the present invention are preferably prepared starting from (poly)alkoxylated (per)fluoropolyether polymers [polymer P*], which comprise at least one (per)fluoropolyoxyalkylene chain [chain (R_{pf})] having two chain ends [end (Rₑ)],

wherein at least one end (Rₑ) comprises a hydroxy-terminated (poly)oxyalkylene chain (R_{a*}) comprising more than 2 fluorine-free oxyalkylene units, said units being the same or different each other and being selected from —CH₂CH(J)O— wherein J is independently selected from hydrogen atom, straight or branched alkyl or aryl, preferably hydrogen atom, methyl, ethyl or phenyl; and

the other end (Rₑ) bears a hydroxy-terminated (poly)oxyalkylene chain (R_{a*}) as defined above or is a neutral group selected from —CF₃, —C₂F₅, —C₃F₇, —CF₂Cl, —CF₂CF₂Cl and —C₃F₆Cl.

When only one of said ends (Rₑ) comprises a hydroxy-terminated (poly)oxyalkylene chain (R_{a*}) and the other end (Rₑ) bears a neutral group as defined above, the polymer is also referred to as “monofunctional polymer P*”.

When both said ends (Rₑ) comprises a hydroxy-terminated (poly)oxyalkylene chain (R_{a*}), the polymer is also referred to as “bifunctional polymer P*”. Preferably, the functionality of the bifunctional polymer P*, i.e. the number of —OH groups, is at least equal to 1.80, more preferably at least equal to 1.85 and still more preferably at least equal to 1.94. The functionality (F) can be calculated for example as disclosed in EP 1810987 A (SOLVAY SOLEXIS S.P.A.).

Said chain (R_{pf}) is as defined above. In a preferred embodiment, said chain (R_{pf}) comprises chain (R_{f}) complying with formula (R_{f}-III) as defined above.

Preferably, said ends (Rₑ) comply with the following general formulae (Rₑ-I) to (Rₑ-III):

—(CH₂CH₂O)ⱼ₁—H (Rₑ-I)

—(CH₂CH(CH₃)O)ⱼ₂—H (Rₑ-II)

—[(CH₂CH₂O)ⱼ₃(CH₂CH(CH₃)O)ⱼ₄]ⱼ₍ₓ₎—H (Rₑ-III)

wherein

j1 and j2, each independently, are an integer from 3 to 50, preferably from 3 to 40, more preferably from 4 to 15, and still more preferably from 4 to 10;

j3, j4 and j(x) are integers higher than 1, such that the sum of j3 and j4 is from 3 to 50, preferably from 3 to 40, more preferably from 4 to 15, and still more preferably from 4 to 10.

More preferably, both said chain ends (Rₑ) comply with formulae (Rₑ-I) to (Rₑ-III) as defined above. Even more preferably, both ends (Rₑ) comply with formulae (Rₑ-I) as defined above.

Polymers P* are commercially available from Solvay Specialty Polymers (Italy) and can be obtained according to the method disclosed in WO 2014/090649 (SOLVAY SPECIALTY POLYMERS ITALY S.P.A.).

Polymers (P) comprising moiety(ies) U of formula (U-I), (U-II) and (U-III) wherein R^{A} is selected from the groups of formula (R^{A}-I) or (R^{A}-II) wherein R^{B} is different from the group of formula (R^{B}-I), can be advantageously prepared by a process comprising:

(a*) reacting at least one polymer P* as defined above with at least one compound [compound (α,β)] comprising at least one α,β-unsaturated carbonyl group.

Suitable examples of said compounds (α,β) are those having the following general formulae:

X—C(O)—CR_{H}═CH₂

X—C(O)—NH—C(O)—CR_{H}═CH₂ and

X—C(O)—R^{A}—CR_{H}═CH₂

O═C═N—R^{B}—[O—C(O)—CR_{H}═CH₂]ₘ

wherein

X is halogen atom, preferably Cl,

R_{H} has the same meaning defined above, more preferably it is hydrogen or methyl,

R^{A} and R^{B} have the same meaning defined above, except that R^{B} is different from group (R^{B}-I), more preferably R^{B} is a divalent or trivalent group selected from C₁-C₆ alkyl chain, C₅-C₇ cycloaliphatic group, C₆ aromatic group, optionally comprising one or more heteroatom(s) selected from N, O and S, and

m is 1 or 2.

Preferred compounds (α,β) are acryloyl chloride, methacryloyl chloride and the like.

Preferably, step (a*) is performed in the presence of a suitable organic solvent, such as for example hydrofluoroethers, hexafluoroxylene, and chloro-hydrocarbons.

Preferably, step (a*) is performed in the presence of a primary or secondary amine compound, such as for example di-isopropylamine, triethylamine and pyridine.

Preferably, step (a*) is performed at a temperature of from 5 to 40° C., more preferably from 15 to 30° C.

Polymers (P) comprising moiety(ies) U of formula (U-IV) as disclosed above can be advantageously prepared by a process comprising: (a**) reacting at least one polymer P* as defined above with at least one allylic halide.

Suitable examples of allylic halides include for example allyl chloride, allyl bromide and allyl fluoride. Allyl bromide being most preferred.

Preferably, step (a**) is performed in the presence of a suitable organic solvent, including for example organic alcohols such as butanol and its isomers. Among organic alcohols, tert-butanol is the most preferred.

Preferably, step (a**) is performed in the presence of a suitable strong base, i.e. a chemical compound that can remove a proton from (or deprotonate) a molecule of a very weak acid in an acid-base reaction. Among strong bases, alkoxides are particularly preferred, including notably potassium tert-butoxide.

Preferably, step (a**) is performed at a temperature of from 5 to 80° C., more preferably from 15 to 50° C.

Polymers (P) comprising moiety(ies) U of formula (U-III) wherein R^{A} is the group of formula (R^{A}-II) wherein R^{B} is the group of formula (R^{B}-I) can be advantageously prepared by a process comprising:

(a***) reacting at least one diisocyanate compound with a compound [compound CU*] bearing at least one unsaturated moiety of formula (U-III) wherein R^{A} is the group of formula (R^{A}-II) as defined above and R^{B} is the group of formula (R^{B}-I); and

(b***) reacting the intermediate obtained in step (a) with at least one (per)fluoropolyether polymer P* as defined above.

Suitable diisocyanate compounds include for example aliphatic and aromatic isocyanate, such as isophoronediisocyanate (IPDI), hexamethylene diisocyanate (HDI), isomers of methylene-bis(cyclohexyl isocyanate) [also referred to as hydrogenated MDI] and mixtures thereof, isomers of methylene diphenyl diisocyanate (MDI) such as 2,2′-MDI, 2,4′-MDI and 4,4′-MDI and mixtures thereof, isomers of toluene diisocyanate (TDI) such as 2,4-TDI and 2,6-TDI, and mixtures thereof. Isophoronediisocyanate is particularly preferred.

Preferably, said compound CU* is selected from hydroxy-[C₁-C₆ alkyl]-acrylate derivatives, notably hydroxyethylacrylate, hydroxymethylacrylate, hydroxypropylacrylate; and alkyl-vinyl-ethers, notably ethylene glycol vinyl ether.

Preferably, step (a***) is performed using a suitable organic solvent, such as for example propyl acetate, butyl acetate, ethyl acetate and mixtures thereof.

Preferably, step (a***) is performed using a catalyst, more preferably selected from tertiary amines, such as tryethylendiamine, N-ethyl-ethylene-imine, tetramethylguanidine; organotin compounds, such as for example dibutyltin dioctanoate and dibutyltin-dilaurate. Organotin compounds are more preferred. Good results have been obtained by using dibutyltin-dilaurate.

Said catalyst are used in an amount not higher than 0.5 wt. % based on the total weight of the reaction mixture.

Preferably, step (a***) is performed using butylated-hydroxytoluene.

Preferably, step (a***) is performed under heating, more preferably at a temperature of from 35° C. to 100° C. The skilled person can determine the duration of the heating depending on the starting materials and on the reaction conditions.

Preferably, step (b***) is performed in the presence of an organic solvent such as ethyl acetate, butyl acetate and mixtures thereof.

Preferably, step (b***) is performed under heating at a temperature of from 40° C. to 100° C. Preferably, heating is performed until the mixture turns limpid. The skilled person can determine the duration of the heating depending on the starting materials and on the reaction conditions.

Polymers (P) according to the present invention can be used as such or a composition [composition (Sᵢ)], containing polymer (P) and a solvent can be prepared. Preferably, said composition (Sᵢ) is in the form of a solution. Suitable solvents are for example, ketones for instance methylethylketone (MEK), methylisobutylketone (MIBK); esters for instance ethyl acetate, butyl acetate, isobutyl acetate; organic solvents containing in the molecule an ester-ether group such as polyoxyethylene monoethyl-ether acetate, polyoxyethylene monobutylether acetate, polyoxy butylene mono-ethyl-ether acetate, polyoxy-butylene monobutylether acetate, polyoxyethylene diacetate, polyoxybutylene-diacetate, 2-ethoxy ethylacetate, ethyleneglycol diacetate, butyleneglycol diacetate. Esters are particularly preferred. Good results have been obtained by using butyl acetate, ethyl acetate and mixtures thereof.

Preferably, said composition (Sᵢ) contains polymer (P) in an amount of from 50 to 90 wt. % based on the total weight of said composition (Sᵢ).

Polymers (P) according to the present invention can be used as additive for example in coating compositions, notably as reactive additive (in other words, as curing agent or hardener) in resins such as epoxy-acrylic resins, polyurethane-acrylic resins, acrylic oligomers and the like, to impart outstanding surface properties including notably water/oil repellency, easy cleanability and stain release.

More in particular, difunctional polymers (P) comprising from 4 to 7 units of formula —CH₂CH(J)O— as defined above, more preferably of formula —CH₂ CH₂O—, can be used as additives in clear coating compositions, for example to be used in the automotive industry.

Typically, a clear coating composition can contain an amount of polymer P of from about 0.01 to less than 5 wt. %, based on the total weight of the coating composition.

Said clear coating composition comprising at least one polymer P according to the present invention can be applied to the surface of a suitable substrate, for example by spraying the composition onto the surface of the substrate, to form a clear (i.e. transparent) coating layer and then cured.

Preferably, a suitable substrate is selected from the group comprising, preferably consisting of, glass; metal, including aluminium, optionally coated with a base coat layer, such as a pigmented base coat layer; and plastic, including polycarbonate (PC), polyvinyl chloride (PVC), thermoplastic olefin (TPO), thermoplastic polyurethane (TPU), polypropylene (PP), acrylonitrile butadiene styrene (ABS) and polyamides (PA).

Said pigmented base-coat layer can be cured, partially cured or uncured and represents the colours and/or special effect-imparting coating layer.

More preferably, said substrate is suitable to be used in the automotive industry for the interior and/or the exterior of vehicles, notably cars. Automotive substrates include in particular car windows and mirrors, automotive bodies and automotive metal or plastic parts. Examples of automotive bodies include truck and vehicle bodies, such as passenger car bodies and van bodies. Examples of automotive body metal or plastic parts can include doors, bonnets, boot lids, hatchbacks, wings, spoilers, bumpers, collision protection strips, slide trim, sills, mirror housing, door handles and hubcaps.

The curing conditions depend on the ingredients of said composition (S) and from the circumstances under which the coating and curing process is carried out.

Any source of radiation can be used. The radiation does can be adjusted by the skilled persons as a function of the composition (S) that is used. Good results have been obtained by applying a radiation of from 200 to 750 W. Preferably, when said step of curing is performed using UV, the curing time is from 1 to 50 seconds, more preferably from 5 to 30 seconds.

Also, polymer (P) according to the present invention can be used as building block in the synthesis of further polymers or it can be cured in order to obtain films.

Should the disclosure of any patents, patent applications, and publications which are incorporated herein by reference conflict with the description of the present application to the extent that it may render a term unclear, the present description shall take precedence.

The invention will be herein after illustrated in greater detail by means of the Examples contained in the following Experimental Section; the Examples are merely illustrative and are by no means to be interpreted as limiting the scope of the invention.

### Experimental Section

Starting materials:
SR256: 2-(2-ethoxyethoxy) ethyl acrylate—slightly water dispersible, monofunctional monomer which acts as a reactive diluent (obtained from Sartomer)
CN9210: hexafunctional aliphatic urethane acrylate (obtained from Sartomer)
DESMODUR® Z4400—isophorone-diisocyanate (IPDI) trimer in methoxypropyl acetate/xylene (obtained from Bayer AG)
Darocure® 1173—2-hydroxy-2-methyl-1-phenyl-propan-1-one—liquid photoinitiator (obtained from CIBA)

Synthesis

Polymer P-1

74.6 g (0.100 moles) of DESMODUR® Z4400, 47 g of ethyl acetate, 32 g of butyl acetate, 0.052 g of dibutyltin-dilaurate, 0.02 g of butylated hydroxytoluene were charged, under nitrogen atmosphere, into a 500 cc reactor equipped with stirrer, thermometer and falling cooler.

24.4 (0.21 moles) of hydroxyethylacrylate were slowly heated in half an hour at 50° C. The mixture was then heated at 70° C. and kept at this temperature for 3 hours.

84.94 g (0.039 moles) of hydroxy-terminated PFPE of formula

HO—(CH₂CH₂O)CH₂CF₂O(CF₂CF₂O)ₐ₁(CF₂O)ₐ₂CF₂CH₂(OCH₂CH₂)ₙOH

having

average number molecular weight=2050,

a1/a2=1.36 and

n=4.5 as average

were loaded in an hour at 70° C. The mixture, initially lacteous, was kept at this temperature for 6 hours obtaining a solution having 70% by weight of product of formula

A-NH—C(═O)—(OCH₂CH₂)_{4.5}—OCH₂CF₂(CF₂CF₂O)ₐ₁(CF₂O)ₐ₂CF₂CH₂O—(CH₂CH₂O)_{4.5}—O—C(═O)—NH—A

wherein each A is a group of formula

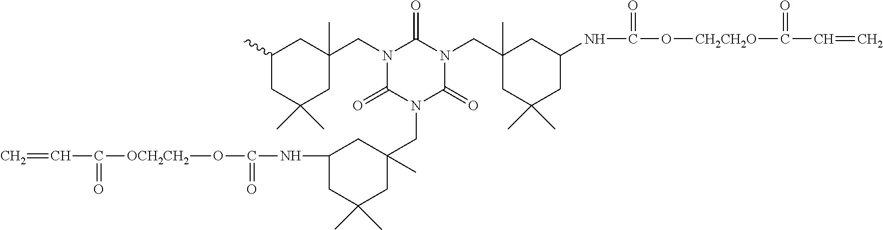

Polymer P-2

Under a nitrogen stream, 10.9 g (0.01 eq.) of hydroxy-terminated PFPE of formula

HO—(CH₂CH₂O)ₙCH₂CF₂O(CF₂CF₂O)ₐ₁(CF₂O)ₐ₂CF₂CH₂(OCH₂CH₂)ₙOH

having

average number molecular weight=2050,

a1/a2=1.36 and

n=4.5 as average

were dissolved in 6 ml of hexafluoroxylene and then 1.61 g (0.013 eq.) of di-isopropylamine were added. The solution was stirred for 30 minutes at room temperature, then 1.08 g (0.012 mol) of acryloyl chloride were added dropwise in an ice bath. After completion of the reaction as monitored by ¹H-NMR, the reaction solution was distilled under vacuum to remove the hexafluoroxylene, the product was washed with distilled water (twice, using 50 ml each time), dried with anhydrous MgSO₄ and filtered to give 11.0 g (99% yield) of the final compound as a slightly yellow liquid

H₂C═CH—(O═)C—(OCH₂CH₂)_{4.5}—OCH₂CF₂—(CF₂CF₂O)ₐ₁(CF₂O)ₐ₂—CF₂CH₂O—(CH₂CH₂O)_{4.5}—C(═O)—CH═CH₂

Polymer P-3

Under a nitrogen stream, 12.4 g (0.01 eq.) of hydroxy-terminated PFPE of formula

HO—(CH₂CH₂O)ₙCH₂CF₂O(CF₂CF₂O)ₐ₁(CF₂O)ₐ₂CF₂CH₂(OCH₂CH₂)ₙOH

having

average number molecular weight=2138,

a1/a2=1.17 and

n=7.5 as average

were dissolved in 10 ml of hexafluoroxylene and then 1.61 g (0.013 eq.) of di-isopropylamine were added. The solution was stirred for 30 minutes at room temperature, then 0.27 g (4.3 mmol) of acryloyl chloride were added dropwise in an ice bath. After completion of the reaction as monitored by ¹H-NMR, the reaction solution was distilled under vacuum to remove the hexafluoroxylene, the product was washed with distilled water (twice, using 50 ml each time), dried with anhydrous MgSO₄ and filtered to give 11.0 g (99% yield) of the final compound as a slightly yellow liquid

H₂C═CH—(O═)C—(OCH₂CH₂)_{4.5}—OCH₂CF₂(CF₂CF₂O)ₐ₁(CF₂O)ₐ₂CF₂CH₂O—(CH₂CH₂O)_{4.5}—C(═O)—CH═CH₂

Polymer P-4

12.4 g (0.01 eq.) of hydroxy-terminated PFPE of formula

HO—(CH₂CH₂O)ₙCH₂CF₂O(CF₂CF₂O)ₐ₁(CF₂O)ₐ₂CF₂CH₂(OCH₂CH₂)ₙOH

having

average number molecular weight=2138,

a1/a2=1.17 and

n=7.5 as average

were dissolved in anhydrous tert-butanol, containing the stoichiometric amount of potassium tert-butoxide. The temperature was raised to 40° C. and 0.021 eq. of allyl bromide were added dropwise. The mixture was kept under vigorous stirring for a total of 4 hours and then the salt was filtered off. Most of the tert-butanol was extracted by repeated washing with water. The organic phase was then dried over anhydrous MgSO₄ and the remaining solvent was removed by evaporation to give 11.0 g (99% yield) of the final compound:

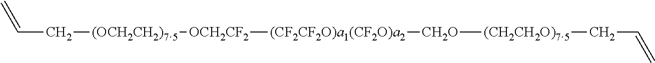

as a slightly yellow liquid.

Polymer P-5

74.6 g (0.10 moles) of DESMODUR® Z4400, 47 g of ethyl acetate, 32 g of butyl acetate, 0.052 g of dibutyltin-dilaurate, 0.02 g of butylated hydroxytoluene were charged under nitrogen atmosphere into a 500 cc reactor, equipped with stirrer, thermometer and falling cooler.

18.5 g (0.21 moles) of ethylene glycol vinyl ether were slowly heated for 30 minutes at 50° C. The temperature was then raised to 70° C. and kept for 3 hours.

84.94 g (0.039 moles) of hydroxy-terminated PFPE of formula

HO—(CH₂CH₂O)ₙCH₂CF₂O(CF₂CF₂O)ₐ₁(CF₂O)ₐ₂CF₂CH₂(OCH₂CH₂)ₙOH

having

average number molecular weight=2050,

a1/a2=1.36 and

n=4.5 as average

were loaded in one hour at 70° C. The mixture initially lacteous was kept at 70° C. for 6 hours, obtaining a solution comprising 70% by weight of the product of formula

A-NH—(O═)C—(OCH₂CH₂)_{4.5}—OCH₂CF₂(CF₂CF₂O)ₐ₁(CF₂O)ₐ₂—CF₂CH₂O—(CH₂CH₂O)_{4.5}—C(═O)—NH—A

wherein each A is a group of formula:

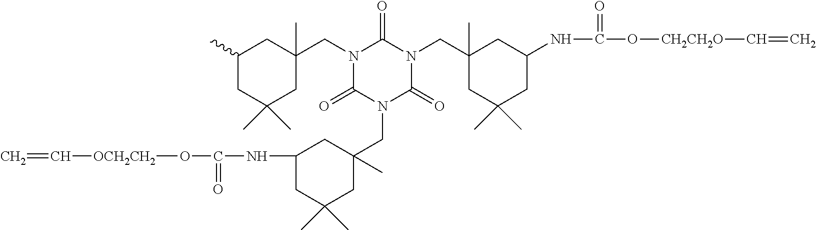

### Example 1

1a—Preparation of the Polyacrylic-Based Formulation

5.0 g of SR256 and 5.0 g of CN9210 were mixed under stirring at room temperature for 15 minutes. Then, 0.2 g of Darocure® 1173 were added (Composition 1*).

Each of Polymers P-1 to P-3 was added to Composition 1* in suitable amounts, so as to obtain an additive concentration in each of Composition 2, 3 and 4 as indicated in Table 1.

1b—Preparation of Coated Support Using Polyacrylic Formulations

Each of Composition 2, 3 and 4 prepared in Example 1a was applied with a doctor blade on three different supports: glass (G), aluminium panel (Al) and polycarbonate (PC), so as to obtain a wet film thickness of 100 microns.

Then, the coatings were UV cured using a UV lamp 500 W and exposition time of 15 seconds. The resulting dry film thickness was 50 microns.

Static contact angle values vs. water and vs. n-hexadecane were measured using con DSA30 (Kruss GmbH, Germany) equipment.

The haziness of the coating on glass was evaluated by visual inspection.

The results are reported in Table 1.

### Example 2—Easy Cleanability Testing

A staining agent (permanent black marker type Pentel® N50) was put on the surface of the different coated supports prepared following the procedure described in Examples 1b, for 24 hours at room temperature.

The results are showed in Table 1.

The results show that the dark stain was easily removed using a dry paper sheet in case of coatings prepared using formulations according to the present invention, wherein a PFPE was used as additive. Differently, an indelible stain was observed when coatings were prepared using the comparative formulation (Composition 1*) free of a PFPE additive.

TABLE 1

| | | | SCA vs. | | | SCA vs. | | | | |
|---|---|---|---|---|---|---|---|---|---|---|
| | Additive | | water | | | hexadecane | | | Glass | |
| Compo- | Poly- | % | (degree °) | | | (degree °) | | | coating | Stain |
| sitions | mer | w/w | G | Al | PC | G | Al | PC | aspect | test |
| 1(*) | — | — | 58 | 66 | n/p | 20 | 25 | 20 | Clear | − |
| 2 | P-1 | 1 | 80 | 90 | n/p | 57 | 64 | n/p | Clear | ++ |
| | | | | | | | | | and | |
| | | | | | | | | | uniform | |
| 3 | P-2 | 0.5 | 99 | n/p | n/p | 70 | n/p | n/p | Clear | ++ |
| | | | | | | | | | and | |
| | | | | | | | | | uniform | |
| 4 | P-3 | 0.5 | 94 | 99 | 101 | 66 | 65 | 66 | Uniform | ++ |

(*)comparative
G = glass
Al = aluminium
PC = polycarbonate
n/p = not performed
In the stain test:
− indicated stain
+ indicated halo
++ indicated no stain

1. A (per)fluoropolyether polymer (P) comprising:
at least one (per)fluoropolyoxyalkylene chain (R_{pf});
at least one (poly)oxyalkylene chain (Rₐ) comprising more than 2 fluorine-free oxyalkylene units, said units being the same or different from each other and being selected from —CH₂CH(J)O—, wherein J is independently selected from hydrogen atom, straight or branched alkyl and aryl; and
at least one unsaturated moiety U;
wherein said at least one moiety U is bonded to said at least one chain (R_{pf}) via said at least one chain (Rₐ);
provided that polymer (P) is different from a polymer of formula
Y—CF₂OR_{f}CFXCH₂(OCH₂CH₂)ₚOCOCR═CH₂
wherein
Y is F, Cl, a perfluoroalkyl group having from 1 to 4 carbon atoms;
X is F, CF₃;
p is an integer from 1 to 5;
R_{f} represents a radical having perfluoropolyetheral structure; and
R is H, CH₃.

2. Polymer P according to claim 1, wherein chain (R_{pf}) is a chain of formula
—O-D-(CFX^{#})_{z1}—O(R_{f})(CFX*)_{z2}-D*-O—
wherein
z1 and z2, equal or different from each other, are equal to or higher than 1;
X^{#} and X*, equal or different from each other, are —F or —CF₃,
provided that when z1 and/or z2 are higher than 1, X^{#} and X* are —F;
D and D*, equal or different from each other, are alkylene chains comprising from 1 to 6 carbon atoms, said alkyl chain being optionally substituted with at least one perfluoroalkyl group comprising from 1 to 3 carbon atoms;
(R_{f}) comprises repeating units R^{o}, said repeating units being independently selected from the group consisting of:
—CFXO—, wherein X is F or CF₃;
(ii) —CFXCFXO—, wherein X, equal or different at each occurrence, is F or CF₃, with the proviso that at least one of X is —F;
(iii) —CF₂CF₂CW₂O—, wherein each of W, equal or different from each other, is F, Cl, or H;
(iv) —CF₂CF₂CF₂CF₂O—; and
(v) —(CF₂)ⱼ—CFZ—O— wherein j is an integer from 0 to 3 and Z is a group of general formula —O-R_{(f-a)}-T, wherein R_{(f-a)} is a fluoropolyoxyalkene chain comprising a number of repeating units from 0 to 10, said recurring units being selected from: —CFXO—, —CF₂CFXO—, —CF₂CF₂CF₂O—, and —CF₂CF₂CF₂CF₂O—, with each of each of X being independently F or CF₃ and T being a C₁-C₃ perfluoroalkyl group.

3. Polymer P according to claim 1, wherein said at least one chain (Rₐ) comprises from 3 to 50 fluorine-free oxyalkylene units.

4. Polymer P according to claim 3, wherein said at least one chain (Rₐ) is selected from:
—(CH₂CH₂O)ⱼ₁—; (Ra-I)
—[CH₂CH(CH₃)O]ⱼ₂; and (Ra-II)
—[(CH₂CH₂O)ⱼ₃—(CH₂CH(CH₃)O)ⱼ₄]ⱼ₍ₓ₎— (Ra-III)
wherein
j1 and j2 each independently are an integer from 3 to 50;
j3, j4 and j(x) are integers higher than 1, such that the sum of j3 and j4 is from 3 to 50.

5. Polymer P according to claim 1, wherein said moiety U is selected from the group consisting of:
—C(═O)—CR_{H}═CH₂; (U-I)
—C(═O)—NH—CO—CR_{H}═CH₂; (U-II)
—C(═O)—R^{A}—CR_{H}═CH₂; and (U-III)
—R_{H1}—CH═CH₂ (U-IV)
wherein
R_{H} is H or a C₁-C₆ alkyl group;
R_{H1} is a sigma bond, an oxygen atom or an alkyl chain having from 1 to 10 carbon atoms;
R^{A} is selected from the group consisting of (R^{A}-I) and (R^{A}-II): 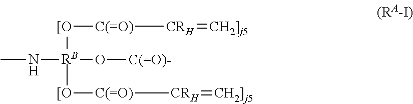
wherein
each of j5 is independently 0 or 1 and
R^{B} is a divalent, trivalent or tetravalent group selected from the group consisting of C₁-C₁₀ aliphatic groups; C₃-C₁₂ cycloaliphatic groups; and C₅-C₁₄ aromatic or alkylaromatic groups, optionally comprising at least one heteroatom selected from N, O and S; 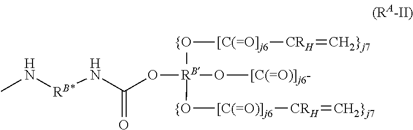
wherein
j6 is 0 or 1;
each of j7 is independently 0 or 1;
R^{B′} is a divalent, trivalent or tetravalent group selected from the group consisting of C₁-C₁₀ aliphatic groups; C₃-C₁₂ cycloaliphatic groups; and C₅-C₁₄ aromatic or alkylaromatic groups, optionally comprising at least one heteroatom selected from N, O and S;
R^{B*} has the same meanings defined above for R^{B′} or it is a group of formula (R^{B}-I): 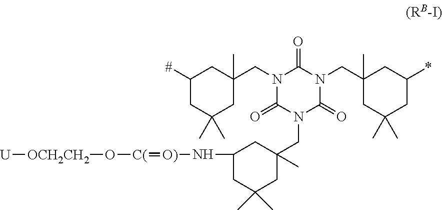
wherein U is selected from the groups (U-I) to (U-IV) and * and # indicate the bonding site to the nitrogen atoms in formula (R^{A}-II).

6. Polymer P according to claim 1, wherein polymer P comprises:
one chain (R_{pf}),
two chains (Rₐ) bonded to opposite sides of said chain (R_{pf}), wherein each chain (Rₐ) bears more than 2 fluorine-free oxyalkylene units as defined in claim 1 and
at least two moieties U.

7. Polymer P according to claim 1, wherein polymer P complies with at least one of the following formulae (P-I) to (P-IV): 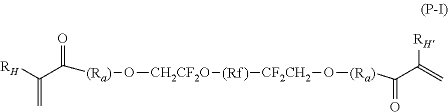 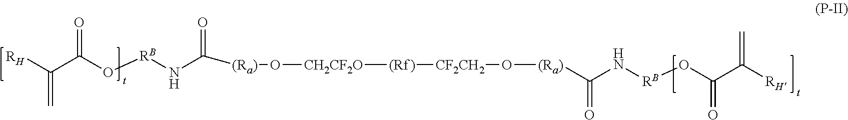 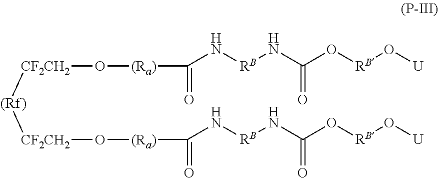 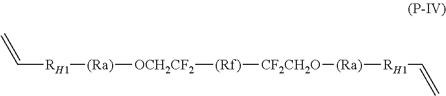
wherein:
(R_{f}) comprises repeating units R^{o}, said repeating units being independently selected from the group consisting of:
(i) —CFXO—, wherein X is F or CF₃;
(ii) —CFXCFXO—, wherein X, equal or different at each occurrence, is F or CF₃, with the proviso that at least one of X is —F,
(iii) —CF₂CF₂CW₂O—, wherein each of W, equal or different from each other, is F, Cl, or H,
(iv) —CF₂CF₂CF₂CF₂O—; and
(v) —(CF₂)ⱼ—CFZ—O— wherein j is an integer from 0 to 3 and Z is a group of general formula —O-R_{(f-a)}-T, wherein R_{(f-a)} is a fluoropolyoxyalkene chain comprising a number of repeating units from 0 to 10, said recurring units being selected from: —CFXO—, —CF₂CFXO—, —CF₂CF₂CF₂O—, and —CF₂CF₂CF₂CF₂O—, with each of each of X being independently F or CF₃ and T being a C₁-C₃ perfluoroalkyl group.
(Rₐ) is a (poly)oxyalkylene chain comprising more than 2 fluorine-free oxyalkylene units, said units being the same or different from each other and being selected from —CH₂CH(J)O—, wherein J is independently selected from hydrogen atom, straight or branched alkyl and aryl,
R_{H} and R^{H′}, equal or different from each other, are independently H or a C₁-C₆ alkyl group;
R_{H1} is a sigma bond, an oxygen atom or an alkyl chain having from 1 to 10 carbon atoms;
t is 1 or 2;
each R^{B}, equal to or different from each other, is a divalent group selected from the group consisting of C₁-C₁₀ aliphatic groups, C₃-C₁₂ cycloaliphatic groups, and C₅-C₁₄ aromatic or alkylaromatic groups, optionally comprising one or more heteroatoms selected from N, O and S, and
each of R^{B′}, equal to or different from each other, is a divalent group selected from the group consisting of C₁-C₁₀ aliphatic groups, C₃-C₁₂ cycloaliphatic groups, and C₆-C₁₄ aromatic or alkylaromatic groups, optionally comprising one or more heteroatoms selected from N, O and S.

8. Polymer P according to claim 1, wherein said polymer P complies with one of the following formulae (P-i) to (P-iv): 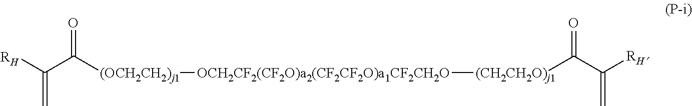
wherein
R_{H} and R_{H′} each independently are selected from hydrogen and methyl;
a1 and a2 are independently integers ≥0 such that the number average molecular weight is between 400 and 10,000; and
each of j1 is an integer from 4 to 10; 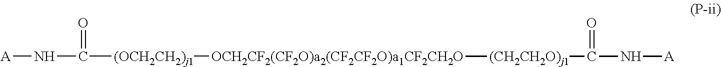
wherein
a1 and a2 are independently integers ≥0 such that the number average molecular weight is between 400 and 10,000;
each of j1 is an integer from 4 to 10; and
each A is a group of formula 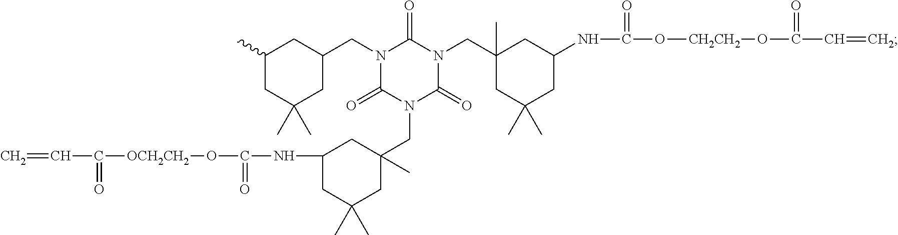 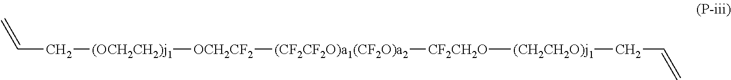
wherein
a1 and a2 are independently integers ≥0 such that the number average molecular weight is between 400 and 10,000 and
each of j1 is an integer from 4 to 10; and 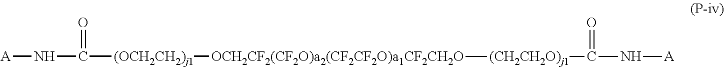
wherein
a1 and a2 are independently integers ≥0 such that the number average molecular weight is between 400 and 10,000;
each of j1 is an integer from 4 to 10; and
each A is a group of formula

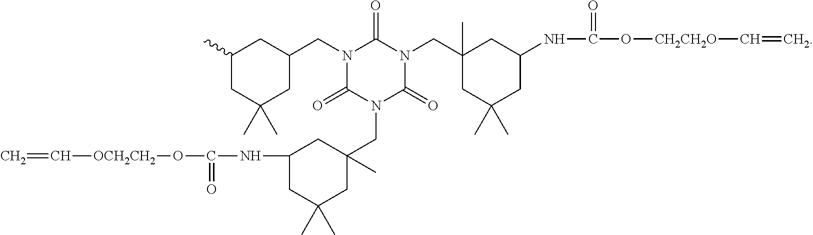

9. A process for the synthesis of polymer (P) comprising at least one moiety U, said moiety U being selected from those of formula:
—C(═O)—CR_{H}═CH₂, (U-I)
—C(═O)—NH—CO—CR_{H}═CH₂, and (U-II)
—C(═O)—R^{A}—CR_{H}═CH₂, (U-III)
wherein
R_{H} is H or a C₁-C₆ alkyl group; and
R^{A} is selected from the group consisting of: 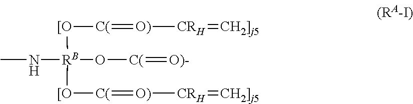
wherein
each of j5 is independently 0 or 1 and
R^{B} is a divalent, trivalent or tetravalent group selected from the group consisting of C₁-C₁₀ aliphatic groups; C₃-C₁₂ cycloaliphatic groups; and C₅-C₁₄ aromatic or alkylaromatic groups, optionally comprising at least one heteroatom selected from N, O and S; 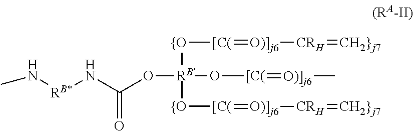
wherein
j6 is 0 or 1;
each of j7 is independently 0 or 1;
R^{B′} is a divalent, trivalent or tetravalent group selected from the group consisting of C₁-C₁₀ aliphatic groups; C₃-C₁₂ cycloaliphatic groups; and C₅-C₁₄ aromatic or alkylaromatic groups, optionally comprising at least one heteroatom selected from N, O and S;
R^{B*} has the same meanings defined above for R^{B′}
said process comprising:
(a*) reacting at least one (poly)alkoxylated (per)fluoropolyether polymer P* with at least one compound (α,β), wherein compound (α,β) comprises at least one α,β-unsaturated carbonyl group,
wherein polymer P* comprises at least one (per)fluoropolyoxyalkylene chain (R_{pf}) having two chain ends (Rₑ),
wherein at least one end (Rₑ) comprises a hydroxy-terminated (poly)oxyalkylene chain (R_{a*}) comprising more than 2 fluorine-free oxyalkylene units, said units being the same or different each other and being selected from —CH₂CH(J)O— wherein J is independently selected from a hydrogen atom, and straight or branched alkyl or aryl groups, and
another end (Rₑ) bears a hydroxy-terminated (poly)oxyalkylene chain (R_{a*}) as defined above or is a neutral group selected from —CF₃, —C₂F₅, —C₃F₇, —CF₂Cl, —CF₂CF₂Cl and —C₃F₆Cl.

10. The process according to claim 9, wherein compound (α,β) is selected from:
X—C(O)—CR_{H}CH₂
X—C(O)—NH—C(O)—CR_{H}═CH₂ and
X—C(O)—R^{A}—CR_{H}═CH₂
O═C═N—R^{B}—[O—C(O)—CR_{H}═CH₂]ₘ
wherein
X is halogen atom, and
m is 1 or 2.

11. A process for the synthesis of polymer (P) comprising at least one moiety U, said moiety U being selected from those of formula:
—R_{H1}—CH═CH₂; (U-IV)
wherein
R_{H1} is a sigma bond or an alkyl chain having from 1 to 10 carbon atoms;
said process comprising:
(a**) reacting at least one (poly)alkoxylated (per)fluoropolyether polymer P* with at least one allylic halide,
wherein polymer P* comprises at least one (per)fluoropolyoxyalkylene chain (R_{pf}) having two chain ends (Rₑ),
wherein at least one end (Rₑ) comprises a hydroxy-terminated (poly)oxyalkylene chain (R_{a*}) comprising more than 2 fluorine-free oxyalkylene units, said units being the same or different each other and being selected from —CH₂CH(J)O— wherein J is independently selected from a hydrogen atom, and straight or branched alkyl or aryl groups, and
another end (Rₑ) bears a hydroxy-terminated (poly)oxyalkylene chain (R_{a*}) as defined above or is a neutral group selected from —CF₃, —C₂F₅, —C₃F₇, —CF₂Cl, —CF₂CF₂Cl and —C₃F₆Cl.

12. The process according to claim 11, wherein said allylic halide is selected from allyl chloride, allyl bromide and allyl fluoride.

13. A process for the synthesis of polymer (P) comprising at least one moiety U, said moiety U having the following formula:
—C(═O)—R^{A}—CR_{H}═CH₂, (U-III)
wherein
R_{H} is H or a C₁-C₆ alkyl group; and
R^{A} is the group of formula: 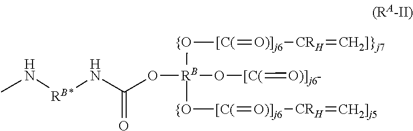
wherein
j6 is 0 or 1;
each j7 is independently 0 or 1;
R^{B′} is a divalent, trivalent or tetravalent group selected from the group consisting of C₁-C₁₀ aliphatic group; C₃-C₁₂ cycloaliphatic group; C₅-C₁₄ aromatic or alkylaromatic group, optionally comprising at least one heteroatom selected from N, O and S;
R^{B*} is a group of formula (R^{B}-I): 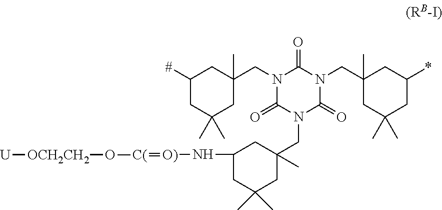
wherein
U is selected from the groups (U-I) to (U-IV) as defined in claim 5 and * and # indicate the bonding site to the nitrogen atoms in formula (R^{A}-II) above;
said process comprising:
(a***) reacting at least one diisocyanate compound with a compound CU* bearing at least one unsaturated moiety of formula (U-III) wherein R^{A} is the group of formula (R^{A}-II) as defined above and R^{B} is the group of formula (R^{B}-I) to form an intermediate; and
(b***) reacting the intermediate obtained in step (a) with at least one (per)fluoropolyether polymer P* as defined above.

14. The process according to claim 13, wherein said diisocyanate compound is selected from the group consisting of: aliphatic and aromatic isocyanates.

15. The process according to claim 13, wherein said compound CU* is selected from hydroxy-[C₁-C₆ alkyl]-acrylate derivatives and alkyl-vinyl-ethers.

16. Polymer P according to claim 2, wherein D and D*, equal or different from each other, are alkylene chains comprising from 1 to 3 carbon atoms, said alkyl chain being optionally substituted with at least one perfluoroalkyl group comprising from 1 to 3 carbon atoms.

17. Polymer P according to claim 3, wherein said at least one chain (Rₐ) comprises from 4 to 10 fluorine-free oxyalkylene units.

18. Polymer P according to claim 6, wherein polymer P comprises:
one chain (R_{pf}),
two chains (Rₐ) bonded to opposite sides of said chain (R_{pf}), wherein each chain (Rₐ) bears more than 2 fluorine-free oxyalkylene units, and
from 2 to 4 moieties U.

19. The process according to claim 14, wherein said diisocyanate compound is at least one compound selected from the group consisting of isophoronediisocyanate, hexamethylene diisocyanate, isomers of methylene-bis(cyclohexyl isocyanate) and mixtures thereof, isomers of methylene diphenyl diisocyanate and mixtures thereof, and isomers of toluene diisocyanate (TDI) and mixtures thereof.

20. The process according to claim 15, wherein said compound CU* is at least one compound selected from hydroxyethylacrylate, hydroxymethylacrylate, hydroxypropylacrylate and ethylene glycol vinyl ether.
